(19) United States
(12) Patent Application Publication
(10) Pub. No.: US 2026/0081414 A1
(43) Pub. Date: Mar. 19, 2026

(54) CONFIGURABLE ELECTRONIC FUSE PROTECTION FOR LOAD SWITCHES

(71) Applicant: Renesas Electronics Corporation, Tokyo (JP)

(72) Inventor: Anand GOPALAN, Plano, TX (US)

(73) Assignee: Renesas Electronics Corporation, Tokyo (JP)

(21) Appl. No.: 18/889,780

(22) Filed: Sep. 19, 2024

(51) Int. Cl. H02H 3/08

(52) U.S. Cl. CPC H02H 3/08

(57) ABSTRACT

An apparatus including an electronic fuse is disclosed. An electronic fuse profile of the electronic fuse can be generated by a circuit of the apparatus. The circuit can set a direct current threshold level for a first region of the electronic fuse profile based at least in part on a first user adjustable parameter, set an over current threshold level for a third region of the electronic fuse profile based at least in part on a third user adjustable parameter and set an integration time constant for a second region of the electronic fuse profile based at least in part on a second user adjustable parameter. The second region can connect the first region to the third region in the electronic fuse profile.

### BACKGROUND

The present disclosure relates in general to semiconductor devices. More specifically, the present disclosure relates to the use of electronic fuses in load switching applications.

Unlike traditional fuses that physically blow when overloaded, electronic fuses (eFUSEs) use electronic components to limit current or disconnect power when certain conditions are met. This allows for more precise control and often enables the fuse to reset automatically without needing replacement. Further, eFUSES, such as those implemented by transistors, can be used or switched repeatedly, thus avoiding the need to change physical fuses after fuses are blown.

A parameter that is a product of a square of the current flowing through a fuse (I) and time (t), denoted as I squared t (I2t), can represent the energy associated with the current (I) flowing through the fuse over a specific period of time (t). It is a measure of the thermal energy generated by the current which determines whether the fuse (e.g., an eFUSE, a transistor) will open to protect the circuit.

An I2t protection scheme may utilize a calculated I2t as part of a decision on whether or not to notify a circuit controller of a potential issue or to even open the fuse. This protection scheme provides protection to components down steam from a switch including, e.g., electrical cables in a wire harness, connectors, printed circuit board (PCB) traces and the fuse itself each of which may have a particular failure profile relative to changes in the I2t parameter.

### SUMMARY

In one embodiment, an apparatus including an electronic fuse and a circuit is disclosed. The circuit can be configured to set a direct current threshold level for a first region of an electronic fuse profile of the electronic fuse based at least in part on a first user adjustable parameter, set an over current threshold level for a third region of the electronic fuse profile based at least in part on a third user adjustable parameter and set an integration time constant for a second region of the electronic fuse profile based at least in part on a second user adjustable parameter. The second region can connect the first region to the third region in the electronic fuse profile.

In one embodiment, a method for implementing an electronic fuse in a system is disclosed. The method comprises setting a direct current threshold level for a first region of an electronic fuse profile based at least in part on a first user adjustable parameter, setting an over current threshold level for a third region of the electronic fuse profile based at least in part on a third user adjustable parameter and setting an integration time constant for a second region of the electronic fuse profile based at least in part on a second user adjustable parameter. The second region can connect the first region to the third region in the electronic fuse profile.

In one embodiment, a system including a load, a controller and an electronic fuse connected between the load and the controller is disclosed. The controller can be configured to set a direct current threshold level for a first region of an electronic fuse profile of the electronic fuse based at least in part on a first user adjustable parameter, set an over current threshold level for a third region of the electronic fuse profile based at least in part on a third user adjustable parameter and set an integration time constant for a second region of the electronic fuse profile based at least in part on a second user adjustable parameter. The second region can connect the first region to the third region in the electronic fuse profile.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a system diagram illustrating an example system including an integrated protection circuit that implements an electronic fuse based on electronic fuse emulation according to an embodiment.

FIG. 2 is a circuit diagram illustrating details of an example electronic fuse emulation circuit of the integrated protection circuit of FIG. 1 according to an embodiment.

FIG. 3 is a diagram of an example electronic fuse profile generated based on the electronic fuse emulation circuit of FIG. 2 according to an embodiment.

FIG. 4 is a table illustrating example registers of control and fault logic of the electronic fuse emulation circuit of FIG. 2 according to an embodiment.

FIG. 5 is a table illustrating example settings in an OC threshold register of the control and fault logic of the electronic fuse emulation circuit of FIG. 2 according to an embodiment.

FIG. 6 is a table illustrating example settings in an I2t IDC coarse adjustment register of the control and fault logic of the electronic fuse emulation circuit of FIG. 2 according to an embodiment.

FIG. 7 is a table illustrating example settings in an I2t IDC fine adjustment register of the control and fault logic of the electronic fuse emulation circuit of FIG. 2 according to an embodiment.

FIG. 8 is a table illustrating example settings in an I2t RC integration time constant adjustment register of the control and fault logic of the electronic fuse emulation circuit of FIG. 2 according to an embodiment.

FIG. 9 is a table illustrating example settings in an It short fuse adjustment register of the control and fault logic of the electronic fuse emulation circuit of FIG. 2 according to an embodiment.

FIG. 10 is a graph illustrating IDC curve values corresponding to the I2t IDC coarse adjustment register of FIG. 5 according to an embodiment.

FIG. 11 is a flowchart illustrating an example process implementing an electronic fuse based on electronic fuse emulation according to an embodiment.

### DETAILED DESCRIPTION

In the following description, numerous specific details are set forth, such as particular structures, components, materials, dimensions, processing steps and techniques, to provide an understanding of the various embodiments of the present application. However, it will be appreciated by one of ordinary skill in the art that the various embodiments of the present application may be practiced without these specific details. In other instances, well-known structures or processing steps have not been described in detail to avoid obscuring the present application.

In some conventional systems, an I2t protection scheme for an eFUSE may be implemented through the use of a lookup table having a fixed number of fuse points. For example, an arbitrary number of fuse points may be chosen on a desired fuse-curve shape. The number of fuse points typically varies from 6 to 15 points with time points ranging from 0.1 ms to 100 ms. The shape of the fuse curve may be arbitrary, and is not necessarily shaped by the energy calculation. The use of a lookup table, however, may be more suited to matching the characteristics of mechanical fuses and typically lacks accuracy due to the quantization error resulting from the limited number of fuse points.

In some other conventional systems, an I2t protection scheme for an eFUSE may be implemented through the use of an equation-based approach. In this case, circuitry is utilized to estimate I2t based on a fixed equation. While the equation-based approach may offer good accuracy, it typically has limited configurability and fuse curve shaping.

An integrated protection scheme disclosed herein can employ load current interrupt sensing with over current (OC) protection in high bandwidth analog solution with, e.g., <1 μs reaction or another bandwidth, for high current transient protection with multiple threshold levels, e.g., 10 A to 50 A, or other threshold levels, which may be set by an OC register.

Further, the integrated protection scheme disclosed herein can utilize I2t protection based on the digitization of the sensed current with configurable fuse curve shaping. The configurable fuse curve shaping may include one or more configurable parameters, e.g., in registers, including, e.g., sixty-four DC current threshold (IDC) settings (2.6 A to 17 A for example), four coarse settings to best match the load current range use case, along with six fine settings to optimize the IDC for protection, four settings for an integration time constant from, e.g., 0.6 s to 4.8 s, and It protection which is configured to handle a non-overlap area of load current that may be under the OC level, but above an ADC full scale level of the digitization, since the device manages the OC protection and I2t protection separately. The It non-overlap area is protected by the It protection with, e.g., one bit for the sensitivity. While each of the above protections are described with example numbers of settings, any other number of settings for the IDC, coarse, fine, integration time constant and It protection settings may alternatively be utilized. Similarly, while example ranges are provided in the above examples for particular protections, any other values or ranges may alternatively be utilized, e.g., based on the particular use case, properties of the material being protected, industry standards or in any other manner.

By utilizing the disclosed integrated protection scheme, the electrical protection of the host system can be ensured including, e.g., protection of the wire harness (cable), connector, PCB traces as well as the load. In addition, by optimizing the settings, unintended switch tripping, e.g., nuisance opening, can be inhibited while maximizing the current carrying capacity.

Furthermore, the integrated protection scheme disclosed herein may also have a secondary thermal protection mechanism to protect the device itself and ensure that the device's own thermal protection does not interfere with the electrical protection that the integrated protection device is providing to the host system during normal operation.

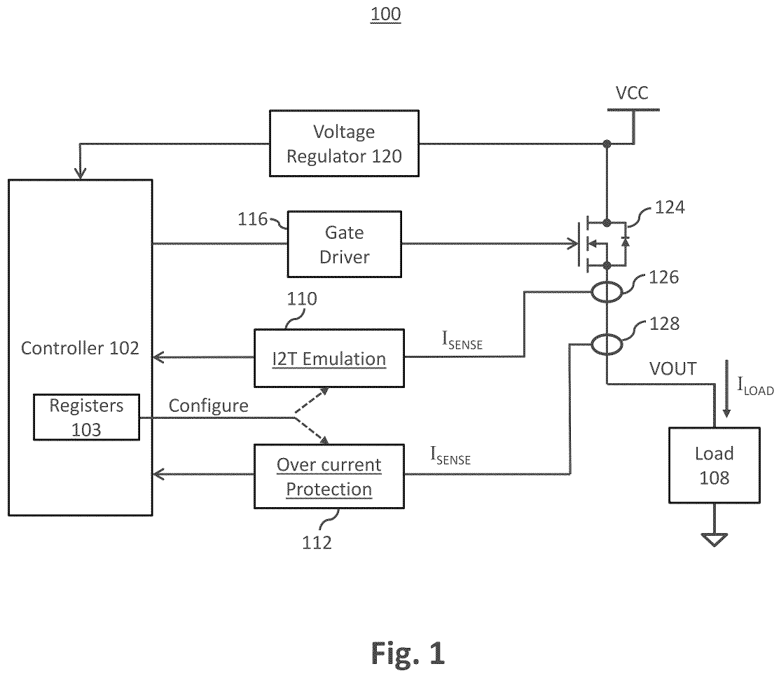

FIG. 1 is a diagram showing an example integrated protection system 100 configured with electronic fuse (eFUSE) emulation capabilities. System 100 comprises a controller 102, a gate driver 114, a main transistor 124, an I2T emulation circuit 110, a over current (OC) protection circuit 112, a voltage regulator 120 and at least one load 108. In one or more embodiments, system 100 can include more than one loads. In the embodiment shown in FIG. 1, I2T emulation circuit 110 can be a separate circuit (e.g., an integrated circuit) from controller 102. In some embodiments (not shown), I2T emulation circuit 110 can be integrated in controller 102. In one embodiment, system 100 can be a powernet system of a vehicle that distribute powers to one or more loads in the vehicle. I2T emulation circuit 110 can also be referred to as control logic, or an electronic fuse emulation circuit. Voltage regulator 120 can be configured to convert power supply voltage VCC into a voltage suitable for operating controller 102.

Controller 102 can be, for example, a microcontroller. Controller 102 can further include various electronic components, such as processors, logic circuits, analog-to-digital converters (ADCs), digital to analog converters (DACs), comparators, mixers, and various electronic components. Controller 102 can also include memory devices, such as registers 103, configured to store various predefined reference values, parameters for configurations, and threshold values that may be needed for operating system 100. Controller 102 can be configured to receive an input signal that indicates whether to turn on or turn off main transistor 124. Controller 102 can convert the input signal into a digital control signal that indicates turn on or turn off, and provide the digital control signal to gate driver 114. Gate driver 114 can convert the digital control signal into a drive voltage for driving a gate of main transistor 124 to control turning on or turning off main transistor 124. When main transistor 124 is turned on (e.g., closed), the power supply VCC can be provided to load 108 (VOUT=VCC). When main transistor 124 is turned off (e.g., opened), power supply VCC does not support load 108. The current I_{L} being drawn by load 108, when main transistor 124 is turned on, can be sensed by controller 102 as sensed current I_{SENSE}.

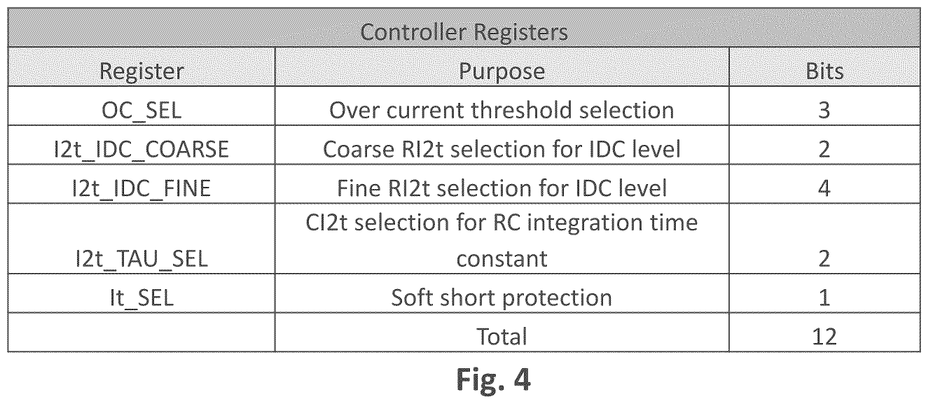

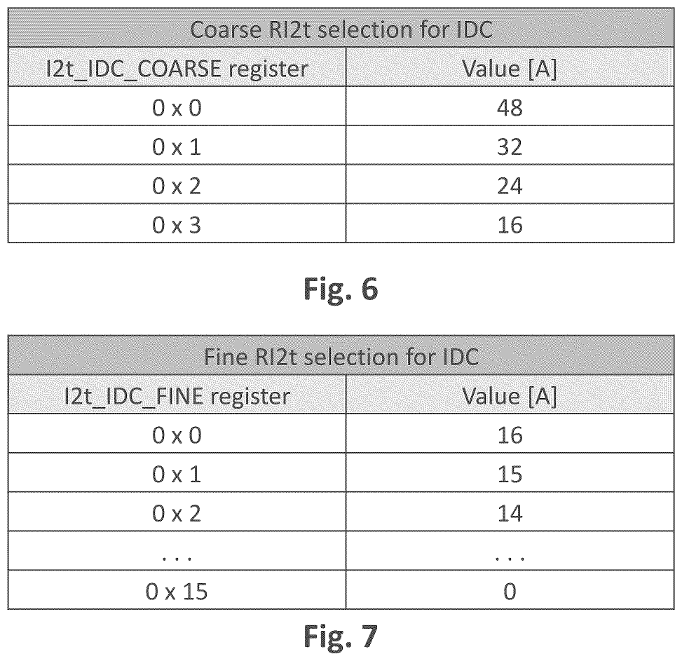

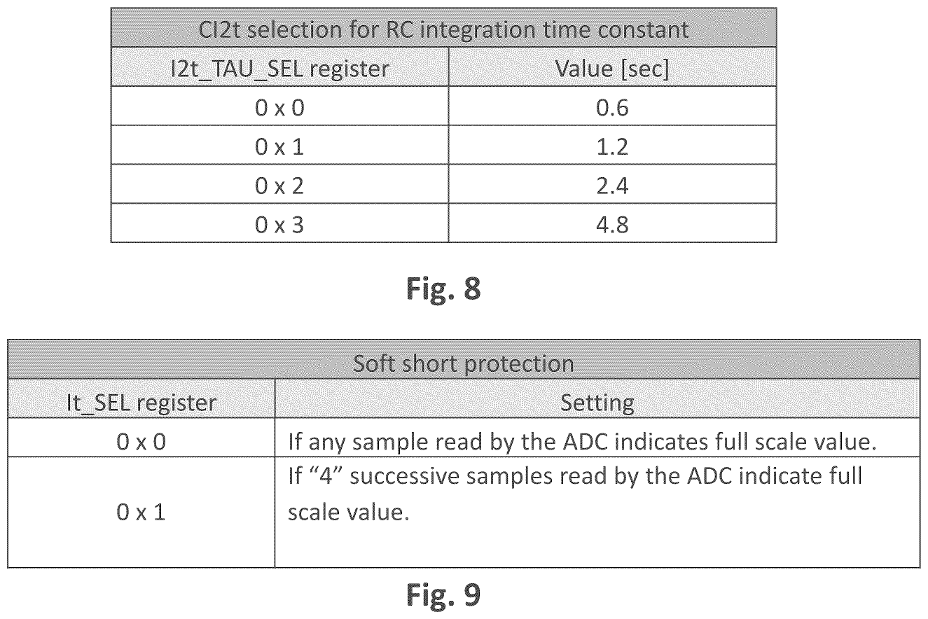

In the example shown in FIG. 1, main transistor 124 can be the eFUSE for load 108. In one embodiment, the I_{SENSE} measured from main transistor 124 can be fed back to I2T emulation circuit 110 and OC protection circuit 112. In the embodiment shown in FIG. 1, a sensing element 126 can be used for sensing I_{SENSE} for I2T emulation circuit 110, and another sensing element 128 can be used for sensing I_{SENSE} for OC protection circuit 112. In one embodiment, sensing elements 126, 128 can be sense resistors connected in parallel with main transistor 124. In some embodiments, controller 102 can also receive I_{SENSE} in order for controller 102 to monitor current being drawn by load 108 (e.g., whether load 108 is drawing too much current). The I_{SENSE} measured from main transistor 124 can be provided to I2T emulation circuit 110 in order for I2T emulation circuit 110 to perform fuse emulation, such as generating a fuse profile of the eFUSE (e.g., main transistor 124). In one embodiment, controller 102 can load values or parameters from registers 103 to configure I2T emulation circuit 110. I2T emulation circuit 110 can generate the fuse profile based on I_{SENSE} and the parameters loaded from registers 103. In one embodiment, controller 102 can load references written in from registers 103 to configure OC protection circuit 112. OC protection circuit 112 can perform over current protection using I_{SENSE} and the references loaded from registers 103. The different registers storing different values among registers 103 are shown in FIG. 4 to FIG. 9. The fuse profile can be used by controller 102 to determine whether to open main transistor 124 to prevent damages to load 108 or other components such as wires, connectors, PCB traces, or the like.

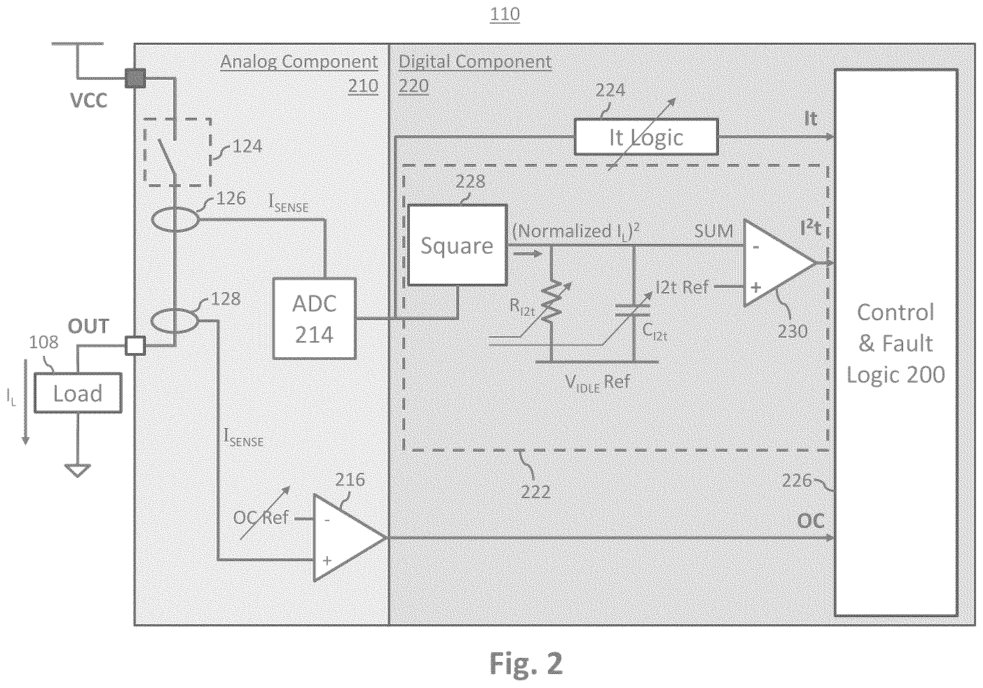

With reference to FIG. 2, I2T emulation circuit 110 can utilize an analog component 210 and a digital component 220. Analog component 210 comprises the main transistor 124, an ADC 214, a comparator 216 and an adjustable over current (OC) reference OC Ref (e.g., a voltage source). Comparator 216 can be a part of OC protection circuit 112 shown in FIG. 1. ADC 214 can be configured to digitize the current I_{SENSE} measured or sensed from sense element 126. The current I_{SENSE} measured or sensed from sense element 128 can be provided to the non-inverting input of comparator 216. The voltage OC Ref can be provided to the inverting input of comparator 216. Comparator 216 can output an OC signal which indicates whether I_{SENSE} exceeds OC Ref or not. In one embodiment, OC Ref can be configured based on reference values loaded from registers 103 shown in FIG. 1.

Digital component 220 of I2T emulation circuit 110 comprises an I2t circuit 222, adjustable It logic 224 and control and fault logic 200. Control and fault logic 200 can be a circuit configured to receive the OC signal from comparator 216 and outputs from I2t circuit 222. Based on the OC signal and outputs from I2t circuit 222, control and fault logic 200 can control an opening and closing of main transistor 124, e.g., by commanding gate driver 116. Adjustable It logic 224 can be logic to configure a parameter It, and the configuration of the It parameter can be based on values stored in registers in control and fault logic 200.

I2t circuit 222 comprises a square circuit 228 that is configured to square the digitized sense current (e.g., multiply by itself), an RC circuit comprising an adjustable I2T resistor R_{I2t}, an adjustable I2T capacitor C_{I2t} and a reference voltage V_{IDLE} Ref, and an I2T comparator 230. The RC circuit can receive an output signal from the square circuit 228, labeled as (Normalized I_{L})² and convert the output signal from square circuit 228 into another signal labeled as SUM. In one embodiment, the RC circuit is configured to perform an I² integration over an RC integration time constant to generates the SUM signal. As the values of adjustable I2T resistor R_{I2t} and adjustable I2T capacitor C_{I2t} change, the value of SUM changes as well. The I2T comparator 230 can compare the output signal SUM with an I2t reference value I2t Ref and output an I²t parameter. In one embodiment, the values of adjustable I2T resistor R_{I2t} and adjustable I2T capacitor C_{I2t} can be configurable by having controller 102 loading the desired values from registers 103.

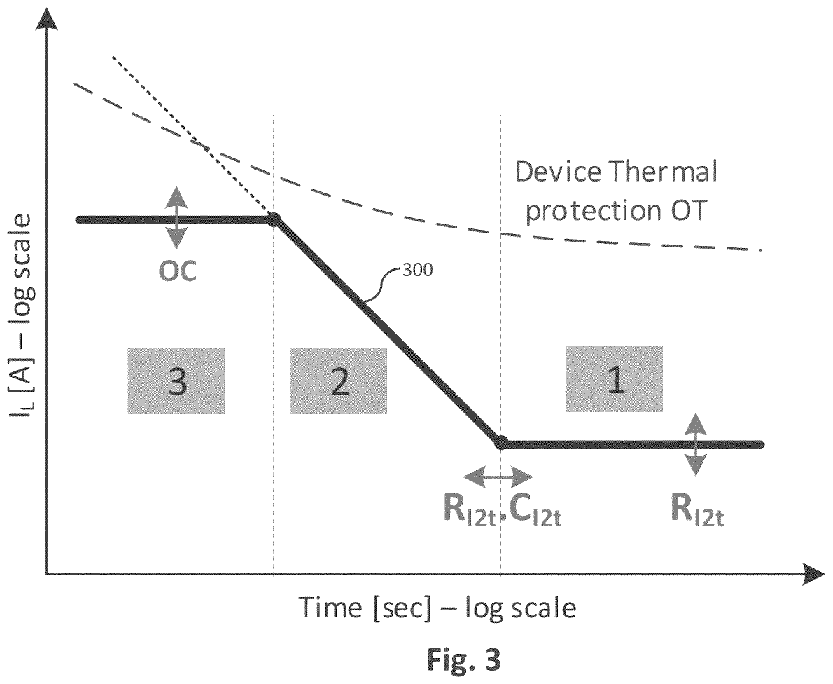

With reference to FIG. 3, I2T emulation circuit 110 can be configured to generate and adjust a fuse profile 300 through the selection of various settings for the adjustable components OC Ref, R_{I2t}, and C_{I2t}, shown in FIG. 2, where each adjustable component is configured to adjust one or more of regions 1, 2 and 3 of the fuse profile 300.

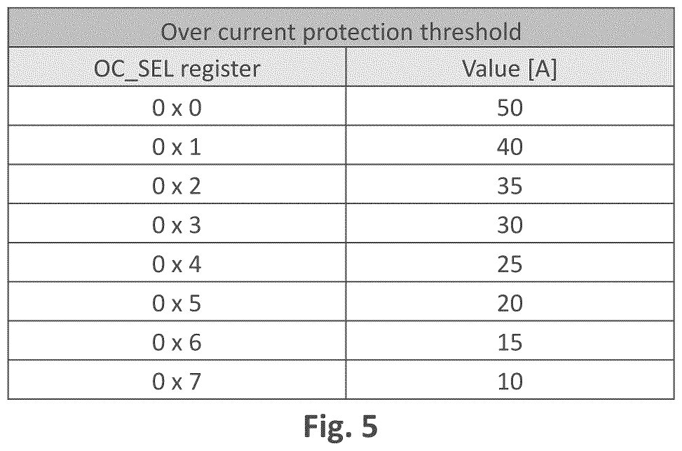

With reference to FIGS. 2-5, comparator 216 can compare the load current I_{L} (or I_{SENSE}) to OC Ref. The comparison of I_{SENSE} and OC Ref can provide an OC protection having a relatively rapid reaction time, e.g., <1 μs in some embodiments, for handling high current transient protection. In an embodiment, OC Ref can be predetermined and adjustable between, for example, eight threshold levels that correspond to region 3 of fuse profile 300. In one embodiment, OC Ref may be set by an OC_SEL register of control and fault logic 200. For example, as shown in FIGS. 4 and 5, the OC_SEL register comprises three bits having eight combinations each of which corresponds to a particular OC threshold value for OC Ref. With reference again to FIG. 3, for example, an increase in the value of OC Ref raises region 3 of the fuse profile 300 relative to the load current I_{L} while a decrease in the value of OC Ref lowers region 3 of the fuse profile 300 relative to the load current I_{L}. While described as having 3 bits and 8 combinations, any other number of bits and combinations may alternatively be utilized by OC_SEL for configuring OC Ref. Similarly, while eight example threshold levels are provided for OC Ref in FIG. 5, any other threshold levels or number of threshold levels may be utilized depending on the use case and characteristics of the components or load through with the monitored current will be flowing.

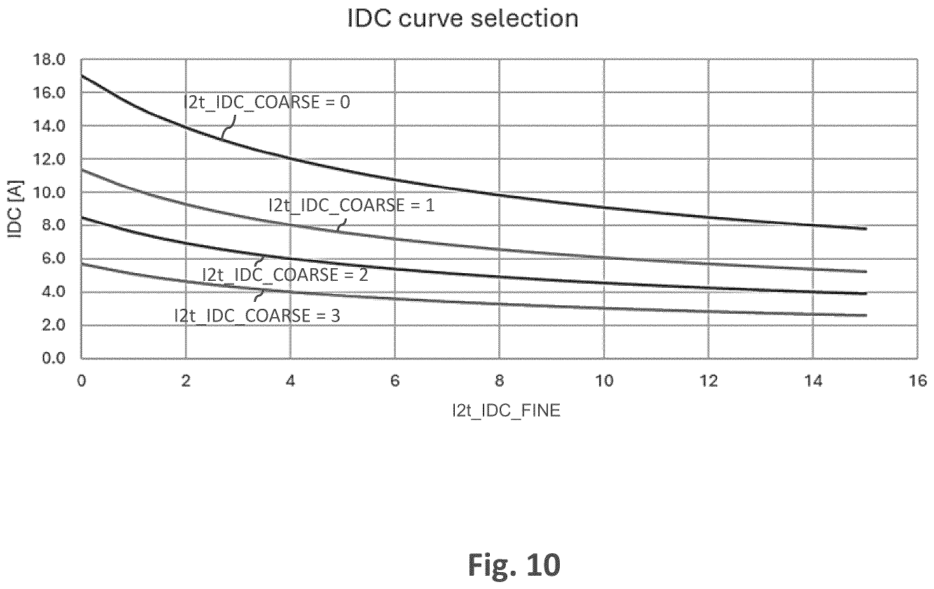

With reference to FIGS. 2-4, 6-8 and 10, I2t circuit 222 can be implemented to provide I2t protection based on the digitized version of the load current I_{L}, or I_{SENSE}, output by ADC 214. The I2t protection comprises adjusting fuse curve shaping via adjustable resistor R_{I2t} and adjustable capacitor C_{I2t}, which can be adjusted individually or simultaneously the RC circuit of I2t circuit 222. In an embodiment, I2t circuit 222 can be adjustable using sixty-four IDC settings including four coarse settings for R_{I2t} to best match the DC current load threshold for the use case, which may be set by the I2t_IDC_COARSE register of control and fault logic 226, and sixteen fine settings for R_{I2t} for optimizing the DC current threshold for protection, which may be set by the I2t_IDC_FINE register of control and fault logic 226. FIG. 9 shows an example chart of the I2t_IDC_COARSE settings as an example. In addition, I2t circuit 222 is further adjustable using four settings for adjusting the RC integration time constant, e.g., by adjusting C_{I2t}, which may be set by the I2t_TAU_SEL register of control and fault logic 200.

Also, the RC circuit in I2t circuit 222 can be a first-order equivalent RC filter that integrates the square of the digitized instantaneous sense current output by square circuit 228. The integration starts from a value V_{IDLE} Ref derived from an idle mode exit current of system 100. A trip (or open) decision is based on the comparison of the instantaneous integration with I2t Ref by I2t comparator 230.

With reference to FIGS. 2-4 and 9, adjustable It logic 224 can be implemented to provide It protection, such as digitizing of the load current I_{L} using ADC 214 and reading register values from control and fault logic 200. Since I2T emulation circuit 110 manages the OC protection and I2t protection separately, through separate sensed current paths from main transistor 124, there may be a non-overlap area of load current I_{L} or I_{SENSE} that may be below the set OC threshold level, but above the ADC full scale level that is handled by the I2t circuit 222. This non-overlap area can be protected by the It protection implemented by adjustable IT logic 224, which in some embodiments comprises loading a one-bit value that is utilized to configure the sensitivity of the It protection, e.g., by a It_SEL register of control and fault logic 226 (see FIG. 4 and FIG. 9). For example, the It_SEL register may be set to 0×0 to set the fuse (main transistor 124) to open when any sample read by the processing and ADC circuit 214 is in the non-overlap area between the OC protection and the I2t protection, the It_SEL register may be set to 0×1 to set the fuse (main transistor 124) to open when four successive samples are read by processing and ADC circuit 214 that are in the non-overlap area, or any other setting for determining when to open the fuse. While described as having two settings and one bit, in other embodiments the It protection may comprise one setting or additional settings and bits, e.g., a single sample, two samples, three samples, four samples or any other number of samples that may be required to trigger the It protection and open the fuse.

With reference again to FIG. 3, the effect of the first order RC integration along with the OC protection is illustrated. As shown in FIG. 3, there are three regions 1, 2, and 3 to the fuse profile 300. Region 1 corresponds to the DC current protection which is determined by the equivalent resistance of adjustable resistor R_{I2t}. Region 2 corresponds to the slow transient current protection which is shaped by the equivalent capacitance of adjustable capacitor C_{I2t}. Region 3 corresponds to the fast transient current protection, which is determined by the OC protection, e.g., OC Ref. I2T emulation circuit 110 can configure all three parameters, R_{I2t}, C_{I2t} and OC Ref, which enables users of system 100 to customize the fuse curve of the eFUSE (main transistor 124) as needed in the application to protect the system.

Referring to FIG. 2, notes that the paths for OC protection and I2t protection can be separated, including separate FETs and support circuitry. In an embodiment, OC protection is an analog-based implementation, with threshold selection through the user configured register OC_SEL. Hence the OC path does not include ADC 214. For the I2t protection, I2T emulation circuit 110 digitizes the sense current using a programmable gain buffer, which may reside in the same circuit block as ADC 214, and the ADC 214. The digitized current enables a coarse and fine adjustments for R_{I2t}. In an embodiment, the sampling rate for the I2t protection and the It protection is 4707 clocks @ 4M Hz, or 1.176 ms. In other embodiments, other sampling rates may alternatively be utilized.

For each channel, system 100 offers twelve bits of configurability as shown in FIG. 4 where, for example, the OC_SEL register which controls the OC threshold selection has 3 bits, the I2t_IDC_COARSE register, which controls the coarse adjustment of R_{I2t} for the IDC, has 2 bits, the I2t_IDC_FINE register which controls the fine adjustment of R_{I2t} for the IDC, has 4 bits, the I2t_TAU_SEL register, which controls the C_{I2t} selection for adjusting the RC time constant, has 2 bits and the It_SEL register, which controls the soft short protection for the non-overlap area, has 1 bit. While a specified number of bits is illustrated and described for each register as an example, any other number of bits or number of selectable options may alternatively be utilized.

Referring to FIGS. 2-9, the IDC value is selected by the I2t_IDC_COARSE register and the I2t_IDC_FINE register. As mentioned above, since the I2T emulation circuit 110 manages the OC protection and I2t protection separately, there may be a non-overlap area of load current I_{L} that may be below the OC level, but above the ADC full scale level output by processing and ADC circuit 214 and handled by the I2t protection. This gap depends on the user selection based on the OC_SEL and I2t_IDC_COARSE and I2t_IDC_FINE registers. This region of operation, though unlikely, may happen due to a specific value of soft short on the output. While some embodiments described the use of I2t_IDC_COARSE and I2t_IDC_FINE registers for coarse and fine adjustment of R_{I2t}, in other embodiments, a single adjustable register may alternatively be utilized for the adjustment of R_{I2t}. In yet other embodiments, additional registers with differing levels sensitivity of adjustment for R_{I2t} may alternatively be utilized.

To expand protection for this region, the adjustable It logic 224 can turns OFF the output based on the setting of the IT_SEL register. For example, if the IT_SEL register is equal to 0, the output to load 108 is turned OFF if there is any sample output by ADC 214, and the value read by It logic 224 can indicate an ADC full scale value. In another example, if the IT_SEL register is equal to 1, the output to load 1108 can be turned OFF if four successive samples output by ADC 214 and the value read by It logic 224 can indicate an ADC full scale value. While the IT_SEL settings for 0×0 and 0×1 are described above as being for a single reading that indicates an ADC full scale value or four successive readings that indicate an ADC full scale value, any other number of readings indicating an ADC full scale value may alternatively be set as one of the IT_SEL settings in other embodiments.

In some embodiments, one or more of registers OC_SEL, I2t_IDC_COARSE, I2t_IDC_FINE, I2t_TAU_SEL and It_SEL may be predefined during manufacturing. In some embodiments, one or more of registers OC_SEL, I2t_IDC_COARSE, I2t_IDC_FINE, I2t_TAU_SEL and It_SEL may be set by an end user during assembly of a particular product that utilizes I2T emulation circuit 110. In some embodiments, one or more of registers OC_SEL, I2t_IDC_COARSE, I2t_IDC_FINE, I2t_TAU_SEL and It_SEL may be adjustable or configurable during operation of the product into which I2T emulation circuit 110 is integrated. For example, a vehicle or other use case utilizing I2T emulation circuit 110 may adjust one or more of registers OC_SEL, I2t_IDC_COARSE, I2t_IDC_FINE, I2t_TAU_SEL and It_SEL during operation according to operational profiles associated with that vehicle or use case to adjust the electronic fuse profile.

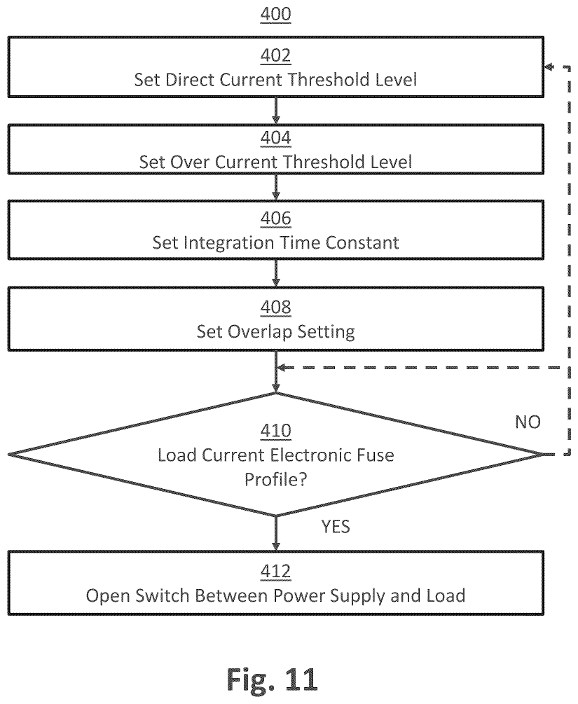

FIG. 11 is a diagram of a flowchart of an example process 400 that implements an electronic fuse based on an electronic fuse profile in an embodiment. Process 400 may be implemented using, for example, I2T emulation circuit 110 of system 100 or any other circuitry of system 100. Process 400 may include one or more operations, actions, or functions as illustrated by one or more of blocks 402, 404, 406, 408, 410 and 412. Although illustrated as discrete blocks, various blocks may be divided into additional blocks, combined into fewer blocks, eliminated, performed in different order, or performed in parallel, depending on the desired implementation. Similarly, additional blocks may be added. The description of FIG. 11 may refer to components shown in FIGS. 1-9.

Process 400 begins at block 402. At block 402, control and fault logic 200 sets a direct current threshold level for a first region of the electronic fuse profile based at least in part on a first user adjustable parameter, e.g., I2t_IDC_COARSE. In some embodiments, the direct current threshold level for the first region of the electronic fuse profile may be set based at least in part on the first user adjustable parameter and a fourth user adjustable parameter, e.g., I2t_IDC_FINE. Setting the direct current threshold level may comprise modifying a value of adjustable resistor R_{I2t}.

At block 404, control and fault logic 200 sets an over current threshold level for a third region of the electronic fuse profile based at least in part on a third user adjustable parameter, e.g., OC_SEL. For example, setting the over current threshold level may comprise modifying a value of OC Ref.

At block 406, control and fault logic 200 sets an integration time constant for a second region of the electronic fuse profile based at least in part on a second user adjustable parameter, e.g., I2t_TAU_SEL. The second region connects the first region to the third region in the electronic fuse profile. Setting the integration time constant may comprise modifying a value of adjustable capacitor C_{I2t}.

At block 408, control and fault logic 200 sets an overlap setting based on a fourth user adjustable parameter, e.g., It_SEL.

At block 410, control and fault logic 200 determines whether a load current is greater than the electronic fuse profile. If the load current is greater than the electronic fuse profile, the process proceeds to block 412. If the load current is less than or equal to the electronic fuse profile, the process returns to blocks 402 to adjust and prior settings or 410 for further monitoring.

At block 412, control and fault logic 226 opens a switch between a power supply and a load based on the determination that the load current is greater than the electronic fuse profile.

While process 400 is described with respect to control and fault logic 200, any other circuitry or component of system 100 may alternatively perform process 400.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
an electronic fuse; and
a circuit configured to:
set a direct current threshold level for a first region of an electronic fuse profile of the electronic fuse based at least in part on a first user adjustable parameter;
set an over current threshold level for a third region of the electronic fuse profile based at least in part on a third user adjustable parameter; and
set an integration time constant for a second region of the electronic fuse profile based at least in part on a second user adjustable parameter, the second region connecting the first region to the third region in the electronic fuse profile.

2. The apparatus of claim 1, wherein the circuit is configured to set the direct current threshold level by modifying a value of an adjustable resistor of an RC circuit to a value that corresponds to the first user adjustable parameter.

3. The apparatus of claim 2, wherein:
the circuit is configured to set the direct current threshold level based at least in part on the first user adjustable parameter and a fourth user adjustable parameter;
the first user adjustable parameter corresponds to a coarse modification of the value of the adjustable resistor; and
the fourth user adjustable parameter corresponds to a fine modification of the value of the adjustable resistor in increments smaller than those of the first user adjustable parameter.

4. The apparatus of claim 2, wherein the circuit is configured to set the integration time constant by modifying a value of an adjustable capacitor of the RC circuit to a value that corresponds to the second user adjustable parameter.

5. The apparatus of claim 4, wherein the circuit is further configured to:
obtain a load current;
digitize the load current;
square the digitized load current;
apply the RC circuit to the squared digitized load current;
compare an output of the RC circuit to a predetermined reference value; and
open a switch between a power supply and a load based on the output of the RC circuit being greater than the predetermined reference current.

6. The apparatus of claim 1, wherein the first, second and third user adjustable parameters are stored in corresponding registers of the circuit.

7. The apparatus of claim 1, wherein the circuit is further configured to:
set an overlap setting based on a fourth user adjustable parameter;
obtain a load current;
digitize the load current using an analog to digital converter;
determine that the digitized load current is a full scale value of the analog to digital converter; and
open a switch between a power supply and a load based on the determination that the digitized load current is a full scale value and the overlap setting.

8. A method for implementing an electronic fuse in system, the method comprising:
setting a direct current threshold level for a first region of an electronic fuse profile based at least in part on a first user adjustable parameter;
setting an over current threshold level for a third region of the electronic fuse profile based at least in part on a third user adjustable parameter; and
setting an integration time constant for a second region of the electronic fuse profile based at least in part on a second user adjustable parameter, the second region connecting the first region to the third region in the electronic fuse profile.

9. The method of claim 8, wherein the method further comprises setting the direct current threshold level by modifying a value of an adjustable resistor of an RC circuit to a value that corresponds to the first user adjustable parameter.

10. The method of claim 9, wherein:
the method further comprises setting the direct current threshold level based at least in part on the first user adjustable parameter and a fourth user adjustable parameter;
the first user adjustable parameter corresponds to a coarse modification of the value of the adjustable resistor; and
the fourth user adjustable parameter corresponds to a fine modification of the value of the adjustable resistor in increments smaller than those of the first user adjustable parameter.

11. The method of claim 9, wherein the method further comprises setting the integration time constant by modifying a value of an adjustable capacitor of the RC circuit to a value that corresponds to the second user adjustable parameter.

12. The method of claim 11, wherein the method further comprises:
obtaining a load current;
digitizing the load current;
squaring the digitized load current;
applying the RC circuit to the squared digitized load current;
comparing an output of the RC circuit to a predetermined reference value; and
opening a switch between a power supply and a load based on the output of the RC circuit being greater than the predetermined reference current.

13. The method of claim 8, wherein the first, second and third user adjustable parameters are stored in corresponding registers of integrated protection circuit.

14. The method of claim 8, wherein the method further comprises:
setting an overlap setting based on a fourth user adjustable parameter;
obtaining a load current;
digitizing the load current using an analog to digital converter;
determining that the digitized load current is a full scale value of the analog to digital converter; and
opening a switch between a power supply and a load based on the determination that the digitized load current is a full scale value and the overlap setting.

15. A system comprising:
a load;
a controller; and
an electronic fuse connected between the load and the controller;
wherein the controller is configured to:
set a direct current threshold level for a first region of an electronic fuse profile of the electronic fuse based at least in part on a first user adjustable parameter;
set an over current threshold level for a third region of the electronic fuse profile based at least in part on a third user adjustable parameter; and
set an integration time constant for a second region of the electronic fuse profile based at least in part on a second user adjustable parameter, the second region connecting the first region to the third region in the electronic fuse profile.

16. The system of claim 15, wherein the controller is configured to set the direct current threshold level by modifying a value of an adjustable resistor of an RC circuit to a value that corresponds to the first user adjustable parameter.

17. The system of claim 16, wherein:
the controller is configured to set the direct current threshold level based at least in part on the first user adjustable parameter and a fourth user adjustable parameter;
the first user adjustable parameter corresponds to a coarse modification of the value of the adjustable resistor; and
the fourth user adjustable parameter corresponds to a fine modification of the value of the adjustable resistor in increments smaller than those of the first user adjustable parameter.

18. The system of claim 16, wherein the controller is configured to set the integration time constant by modifying a value of an adjustable capacitor of the RC circuit to a value that corresponds to the second user adjustable parameter.

19. The system of claim 18, wherein the controller is further configured to:
obtain a load current;
digitize the load current;
square the digitized load current;
apply the RC circuit to the squared digitized load current;
compare an output of the RC circuit to a predetermined reference value; and
open a switch between a power supply and a load based on the output of the RC circuit being greater than the predetermined reference current.

20. The system of claim 15, wherein the controller is further configured to:
set an overlap setting based on a fourth user adjustable parameter;
obtain a load current;
digitize the load current using an analog to digital converter;
determine that the digitized load current is a full scale value of the analog to digital converter; and
open a switch between a power supply and a load based on the determination that the digitized load current is a full scale value and the overlap setting.
